(19) United States
(12) Patent Application Publication
(10) Pub. No.: US 2013/0081328 A1
(43) Pub. Date: Apr. 4, 2013

(54) PROCESS FOR PROVIDING A LOW-CARBON FUEL FOR REFINING OPERATIONS

(71) Applicant: Raja Ankush Jadhav, Benicia, CA (US)

(72) Inventor: Raja Ankush Jadhav, Benicia, CA (US)

(73) Assignee: Chevron U.S.A. INC., San Ramon, CA (US)

(21) Appl. No.: 13/248,952

(22) Filed: Sep. 29, 2011

(51) Int. Cl. C01B 3/02

(52) U.S. Cl. 48/127.3; 48/197 R

(57) ABSTRACT

An integrated process provides a low-carbon fuel gas for use in refinery equipment such as heaters and boilers. The process utilizes a hydrogen separation membrane to separate a refinery fuel gas into a first hydrogen-enriched stream and a hydrogen-depleted stream containing methane. The hydrogen-depleted stream is subjected to reforming and water gas shift, and the resulting shifted gas mixture containing hydrogen and carbon dioxide is subjected to separation into a second hydrogen-enriched stream and a carbon dioxide stream. The first and second hydrogen-enriched streams are combined and utilized as low-carbon fuel gas containing at least about 50 mol % hydrogen. Sweep gas is provided across the permeate side of the hydrogen separation membrane to improve the performance of the membrane unit. The sweep gas can be taken from the exhaust of the refinery equipment, from an air separation unit and/or from a carbon dioxide-depleted stream generated in the reforming process.

### FIELD

The present disclosure relates to a process for treating a gaseous mixture such as a refinery fuel gas to provide a low-carbon fuel gas. The disclosure further relates to the use of such low-carbon fuel gas as fuel for refinery equipment.

### BACKGROUND

Within operations for refining petroleum products, refinery equipment such as heaters and boilers are a significant source of carbon dioxide emissions. Such equipment is typically fueled by refinery fuel gas (RFG) used throughout the refinery and containing hydrogen, methane as well as other hydrocarbon components. The carbon dioxide emissions can be controlled using a known amine solvent-based post-combustion carbon capture process. However, this requires a large amount of area which is not always available in a refinery.

It has been proposed that refinery equipment be fueled by hydrogen fuel produced by reforming RFG in a steam methane reformer (SMR) or autothermal reformer (ATR) fitted with a carbon dioxide capture technology. Since the RFG can contain as much as 30 mol % hydrogen, it is advantageous to separate a majority of the hydrogen from the RFG first. Known hydrogen separation membranes can be used for this purpose. The pressure differential across the membrane determines the flux, i.e. the flow rate of hydrogen per unit area per unit time across the membrane. In order to achieve high recovery of hydrogen, the size in terms of area of the membrane can be increased, the feed can be compressed to increase the pressure on the feed side and/or the pressure on the permeate side of the membrane can be reduced. Each of these has disadvantages in terms of cost, space requirements and energy usage for compression of the feed or recompression of the permeate.

It would be desirable to provide an integrated process that would produce a low-carbon fuel gas for use in refinery equipment in a way that is energy efficient and reduces carbon dioxide emissions from such refinery equipment.

### SUMMARY

According to one embodiment, the present disclosure relates to a process for providing a fuel gas for refining operations, in which a first gaseous mixture containing hydrogen and methane is passed across one side of a first hydrogen separation membrane to form a first hydrogen-enriched stream and a first hydrogen-depleted retentate stream containing methane. A sweep gas is passed across the other side of the membrane to enhance hydrogen flux across the membrane. The first hydrogen-depleted retentate stream is subjected to a reforming operation to form a second gaseous mixture containing hydrogen, carbon monoxide, carbon dioxide and water. The second gaseous mixture is passed through a water gas shift reactor to form a third gaseous mixture containing hydrogen and carbon dioxide. The third gaseous mixture is separated into a second hydrogen-enriched stream and a carbon dioxide stream. The first and second hydrogen-enriched streams are combined to form a low-carbon fuel gas stream containing at least about 50 mol % hydrogen.

### BRIEF DESCRIPTION OF THE DRAWINGS

FIG. 1 is a schematic diagram illustrating a process for providing a low-carbon fuel according to one exemplary embodiment.

FIG. 2 is a schematic diagram illustrating one possible separation unit for use in the process illustrated in FIG. 1.

FIG. 3 is a schematic diagram illustrating alternative schemes for integrating a gas stream from the separation unit of FIG. 2 with the process of FIG. 1 for providing a low-carbon fuel.

FIG. 4 is a schematic diagram illustrating a process for utilizing a low-carbon fuel and producing an alternative sweep gas stream according to another exemplary embodiment.

### DETAILED DESCRIPTION

A process and system are disclosed to reduce CO₂ emissions from combustion equipment found in refineries such as heaters and boilers, herein also referred to as “refinery equipment.” Conventionally, the refinery equipment is fueled by refinery fuel gas (RFG) and/or natural gas.

As a result of the presence of carbon components in the fuel, such equipment is a significant source of CO₂ emissions in a refinery. A low-carbon fuel gas stream containing at least about 50 mol % hydrogen, also referred to interchangeably herein as “H₂ fuel,” can be used as a fuel for refinery equipment to reduce or eliminate CO₂ emissions.

The H₂ fuel can be produced by reforming RFG in a reformer, such as a steam methane reformer (SMR) or an autothermal reformer (ATR). By “reforming” is meant the reaction of a hydrocarbon mixture with an oxidizing agent such as oxygen and/or steam, usually in the presence of a catalyst, to form hydrogen, carbon monoxide, carbon dioxide and water. The RFG may contain up to about 30 mol % H₂, so it is advantageous to separate a majority of H₂ from the RFG before sending it to the reformer. The separated H₂ is mixed with the H₂ formed in the reformer and used as a fuel in the refinery equipment. Removal of H₂ from the RFG has a number of potential advantages, including a decrease in the required size of the reformer, increase in hydrogen formation in the reformer, and decrease in the amount of O₂ required in the ATR (where applicable).

The H₂ can be separated from the RFG by use of a hydrogen membrane, also referred to herein as the “first hydrogen membrane.” Several membrane types are suitable for use in the present process, including polymeric, metallic, and porous inorganic membranes including carbon molecular sieve (CMS) and ceramic. The RFG is sent to the feed or retentate side of the membrane and H₂ permeates through the membrane to the permeate side in the first hydrogen-enriched stream. The remaining RFG, also referred to as the hydrogen-depleted retentate stream, now substantially devoid of H₂, leaves the membrane from the retentate side. The difference in the partial pressure of the H₂ between the two membrane sides forms the driving force for H₂ separation, and the hydrogen flux across the membrane is directly proportional to this partial pressure difference. By “hydrogen flux” is meant the volumetric flow rate of hydrogen permeate across the membrane per unit of membrane area over time, which can be expressed as cm³/cm²/min. Thus, in order to increase the hydrogen flux, to increase the H₂ recovery and/or to reduce membrane area, the feed pressure is increased or the retentate pressure is reduced, or both. Since the feed RFG contains significant amounts of components other than H₂, its compression to higher pressures requires a significant amount of energy. Therefore, it is advantageous instead to reduce the partial pressure of the H₂ in the retentate stream by sending a sweep gas stream to the permeate side of the membrane, which increases the hydrogen flux across the membrane. According to one exemplary embodiment, the sweep gas stream utilizes N₂ taken from the exhaust gas of refinery equipment and/or from an air separation unit (ASU). The former source of the sweep gas is advantageous when there is no ASU located nearby, for example, when the H₂ is produced from RFG in a SMR instead of an ATR.

In one embodiment, N₂ taken from the exhaust gas from refinery equipment is used as a sweep gas. The refinery equipment is fired with the H₂ fuel thus obtained in the presence of air. The exhaust gas contains primarily N₂, H₂O and a small amount of O₂. The exhaust gas has a pressure of near-atmospheric and a temperature generally in the range of about 100° C.-about 300° C. In order to utilize a portion of the exhaust gas as the sweep gas, the exhaust gas is first optionally cooled in a heat exchanger to a temperature in the range about 30° C.-about 50° C. to condense out most of the water which is next optionally removed in a separator column. A direct contact cooler may also be used to lower the flue gas temperature. The cooled sweep gas stream is next compressed to a pressure of about 3 to about 6 bar in a compressor. The O₂ in the sweep gas stream is optionally removed in a catalytic de-oxo unit, which is supplied with a small amount of H₂, which can be taken from the hydrogen-enriched permeate stream of the H₂ membrane. The removal of O₂ upstream of the membrane unit can be advantageous to limit the temperature rise in the membrane from the reaction between H₂ and O₂ in the sweep stream, particularly when the membrane is operated at temperatures in excess of about 150° C. The use of the compressor and the catalytic de-oxo unit can increase the temperature of the sweep gas stream, as known to those skilled in the art. This can be advantageous to approximate the temperature of the membrane unit, if high-temperature membranes are employed. The H₂-enriched permeate stream is mixed with the H₂ produced in the reforming process and can be supplied to refinery equipment as a high hydrogen content and low carbon content fuel.

In an alternative embodiment, the membrane sweep gas stream may be obtained from a reforming process. In this embodiment, a reforming process converts hydrocarbons into a mixture of hydrogen and carbon oxides. Any known reforming process can be used, including steam methane reforming (SMR) in which hydrocarbons (HCs) react with steam in an endothermic process, partial oxidization (PDX) in which HCs react with oxygen in an exothermic process, and a combination of these two referred to as autothermal reforming (ATR) in which HCs react with both steam and oxygen to produce H₂ and carbon oxides. In the reforming process, a pre-reformer may be employed to convert higher HCs (C₂₊) into methane, and thus avoid carbon formation in the main reformer. The gas exiting the reformer, also referred to as syngas, consists of H₂, CO, CO₂, H₂O, and unconverted CH₄. The syngas is sent to a heat recovery steam generator (HRSG) to cool the gas stream and simultaneously generate high pressure steam. The cooled syngas is sent to a high temperature shift reactor (HTS) and low temperature shift (LTS) reactor to convert most of the carbon monoxide (CO) and water vapor into hydrogen (H₂) and carbon dioxide (CO₂) by employing the water gas shift (WGS) reaction.

Separation of H₂ from the shifted syngas can be accomplished by sending the shifted syngas stream to a H₂ selective membrane, also referred to as the “second hydrogen membrane,” where a majority-H₂ stream, also referred to as the second hydrogen-enriched stream, is separated from the syngas stream. More than a single stage of membranes may be used and the shift reactor may be integrated with the membrane process to increase the CO conversion into H₂ and simultaneously increase H₂ recovery across the membrane. Suitable membranes for this application include metallic membranes, and porous inorganic membranes such as carbon molecular sieves (CMS) and ceramic membranes. These membranes are suitable for use in the temperature range about 150° C.-about 500° C. The hydrogen-depleted retentate stream from the membrane consists primarily of CO₂ with minor amounts of H₂, CO, and CH₄. The CO₂ from the hydrogen-depleted retentate stream can be separated from the rest of the components in a cryogenic CO₂ purification unit (CPU), such as those described in U.S. Patent Application Nos. U.S. 2010/0024476, U.S. 2008/0176174, and U.S. 2008/0173585, incorporated herein in their entirety by reference. The carbon dioxide-depleted stream from the CPU containing primarily CH₄, H₂, and CO with minor amounts of CO₂, which can be advantageously used as a sweep gas for use with the H₂ membranes (the first and/or second hydrogen membranes), in combination with the RFG stream to recover additional H₂ in the first membrane, and/or as a recycle stream to the reformer after any pre-reformer to recycle the CH₄. A purge on the recycle stream may be conducted to avoid accumulation of inert gases in the process.

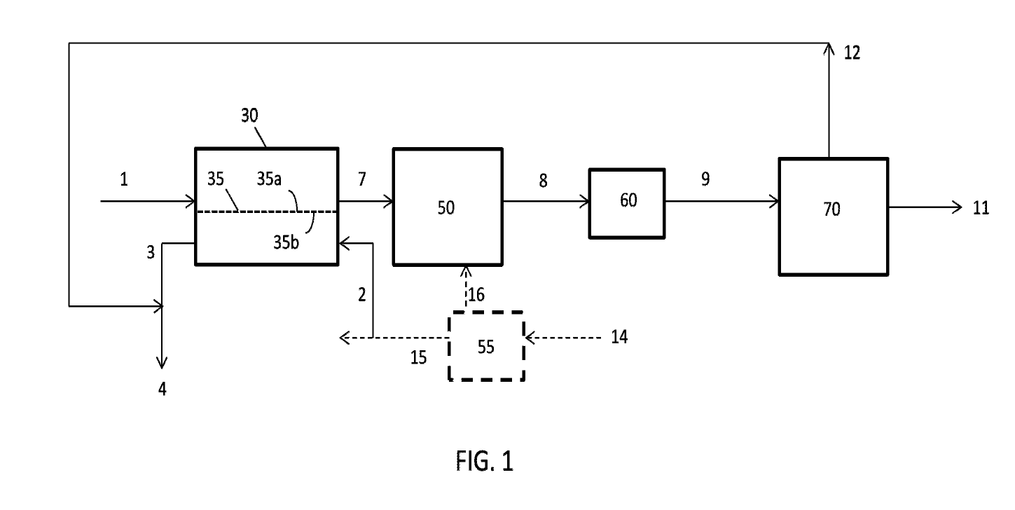

Referring to FIG. 1, a first gaseous mixture 1 containing hydrogen and methane is supplied as a feed gas to membrane module 30. By way of example and not limitation, the first gaseous mixture 1 can be a refinery fuel gas (RFG). First gaseous mixture 1 may also contain other gaseous components, including, but not limited to N₂, CO, CO₂, H₂O, H₂S, C₂H₆, C₂¹⁴₄, and other higher hydrocarbons. The first gaseous mixture 1 contains at least about 5 mol % hydrogen. In one exemplary embodiment, the first gaseous mixture may be pressurized to a pressure of between about 10 and about 30 bar using a compressor (not shown).

Within membrane module 30, first gaseous mixture 1 passes across one side, herein referred to as the retentate side 35a, of a hydrogen separation membrane 35. The other side of the membrane is referred to as the permeate side 35b. A sweep gas 2 is passed across the permeate side 35b. A hydrogen-depleted retentate stream 7 containing methane is removed from the membrane module 30 from the retentate side 35a of the membrane 35. A permeate stream containing hydrogen, also referred to as a first hydrogen-enriched stream 3, is also removed from the membrane module 30, from the permeate side 35b of the membrane 35. The first hydrogen-enriched stream 3 contains at least about 10 mol % hydrogen.

Suitable hydrogen separation membranes for use in the present process include metallic membranes (e.g., palladium alloy membranes), porous inorganic membranes (e.g., silica, zeolite, alumina and carbon molecular sieve membranes), and nonporous polymeric membranes.

The hydrogen-depleted retentate stream 7 is reformed to form a second gaseous mixture 8 containing hydrogen, carbon monoxide, carbon dioxide and water in a reformer 50. Second gaseous mixture 8 can also include unreacted methane. The retentate stream 7 may be compressed to a pressure in the range about 20 to about 30 bar using a compressor (not shown). In one embodiment, reformer 50 is an autothermal reformer used in conjunction with an air separation unit 55. Air separation unit 55 receives air 14 which is separated into nitrogen-containing gas stream 15 and oxygen stream 16, which in turn feeds reformer 50.

According to one embodiment, a portion of the nitrogen-containing gas stream 15 removed from air separation unit 55 is used as the sweep gas 2 across the permeate side of the membrane 35.

The second gaseous mixture 8 is next sent to a water gas shift reactor 60 in which the carbon monoxide and water vapor of the gas mixture 8 are converted in the presence of a suitable catalyst to a third gaseous mixture 9 primarily containing hydrogen and carbon dioxide, as known to those skilled in the art.

The third gaseous mixture 9 is next sent to a separation unit 70 which separates the gaseous mixture 9 into a second hydrogen-enriched stream 12 and a carbon dioxide-containing stream 11. The second hydrogen-enriched stream 12 can contain small amounts of methane, carbon monoxide and carbon dioxide. In one embodiment, the second hydrogen-enriched stream 12 contains at least about 70 mol % hydrogen. The carbon dioxide-containing stream 11 can contain other components as well.

In one embodiment, the separation unit 70 is a carbon dioxide absorption unit in which carbon dioxide is absorbed into a solvent. Suitable solvents can be selected from, for example, methyl diethanolamine, dimethyl ether of polyethylene glycol, refrigerated methanol and the like.

In an alternative embodiment, the separation unit 70 is a membrane module utilizing a hydrogen separation membrane. Passing the third gaseous mixture 9 over the membrane results in second hydrogen-enriched stream 12 as the permeate stream and carbon dioxide stream 11 as the hydrogen-depleted retentate stream.

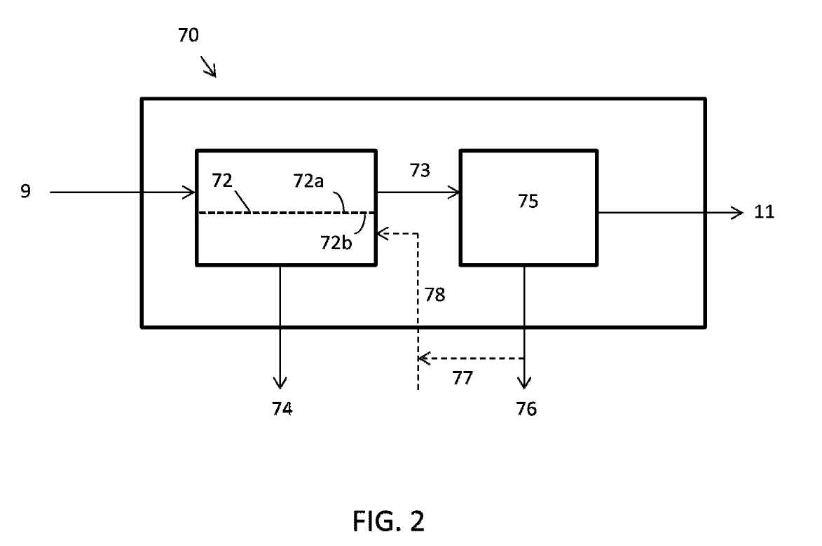

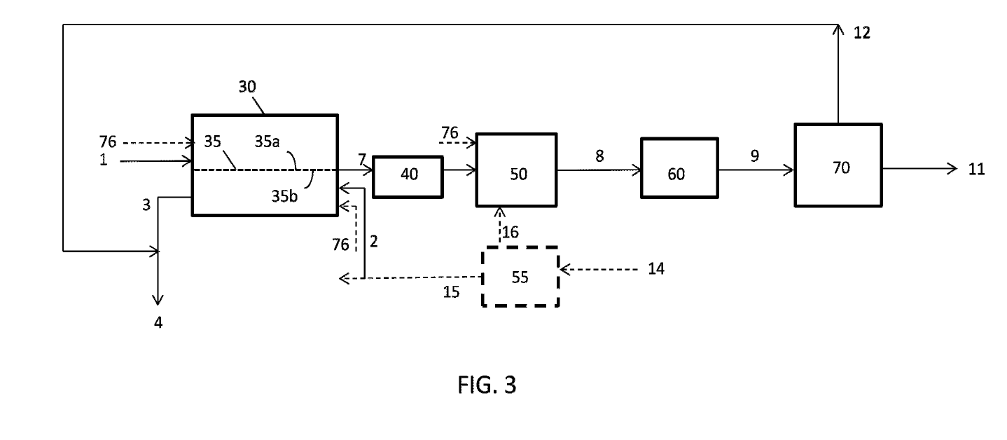

In yet another alternative embodiment, shown in FIG. 2, the separation unit 70 includes a second hydrogen separation membrane 72, as well as a cryogenic carbon dioxide purification unit 75. In this case, third gaseous mixture 9 is passed across the retentate side of hydrogen separation membrane 72a to form a hydrogen-enriched permeate stream 74 and a hydrogen-depleted retentate stream 73. Hydrogen-enriched permeate stream 74 can be combined with first hydrogen stream 3 to form the low-carbon fuel gas 4. Hydrogen-depleted retentate stream 73 is then passed through the cryogenic purification unit 75 to condense out the carbon dioxide as stream 11. The non-condensable gases from the cryogenic purification unit 75 form a carbon dioxide-depleted stream 76 containing hydrogen, methane and small amounts of carbon dioxide, carbon monoxide and possibly other components such as nitrogen and argon. There are a number of alternative uses for this stream 76. Referring to FIG. 3, a system similar to FIG. 1 is shown. In one embodiment, the carbon dioxide-depleted stream 76 can be passed across the permeate side 35b of the first hydrogen separation membrane 35 as a sweep gas, either alone or in combination with nitrogen-containing stream 2. In another embodiment, the carbon dioxide-depleted stream 76 can be passed across the retentate side 35a of the first hydrogen separation membrane 35 as at least a portion of the feed gas. In yet another embodiment, the carbon dioxide-depleted stream 76 can be sent to reformer 50, after any pre-reformer 40 used to reform C₂₊components, directly as a feed gas. In another embodiment, referring again to FIG. 2, all or a portion 77 of the carbon dioxide-depleted stream 76 can be passed across the permeate side 72b of the second hydrogen separation membrane 72 as a sweep gas 78. In another embodiment, the carbon dioxide-depleted stream 76 can be sent to a combination of one or more of the above described components, i.e., membrane 35, reformer 50 and membrane 72.

The second hydrogen-enriched stream 12 is then combined with the first hydrogen-enriched stream 3 to form the low-carbon fuel gas 4. The low-carbon fuel gas 4 contains at least about 50 mol % hydrogen. By way of example and not limitation, the fuel gas can have a lower heating value (LHV) between about 280 and about 310 BTUs per standard cubic foot. This low-carbon fuel gas 4 can be used within refining operations as fuel for refinery equipment, such as, for instance, heaters and boilers. Carbon dioxide emissions from such heaters and boilers using the low-carbon fuel gas 4 are at least about 50% lower than carbon dioxide emissions when conventional refinery fuel gas or natural gas is used as fuel. In one embodiment, the fuel gas 4 can be mixed with conventional refinery fuel gas or with natural gas prior to using in refinery equipment, e.g. heaters and boilers, to reduce the carbon dioxide emissions as compared with refinery fuel gas or natural gas alone. In another embodiment, steam or water can be injected in the combustion zone of the refinery equipment in order to absorb heat and moderate the combustion temperature.

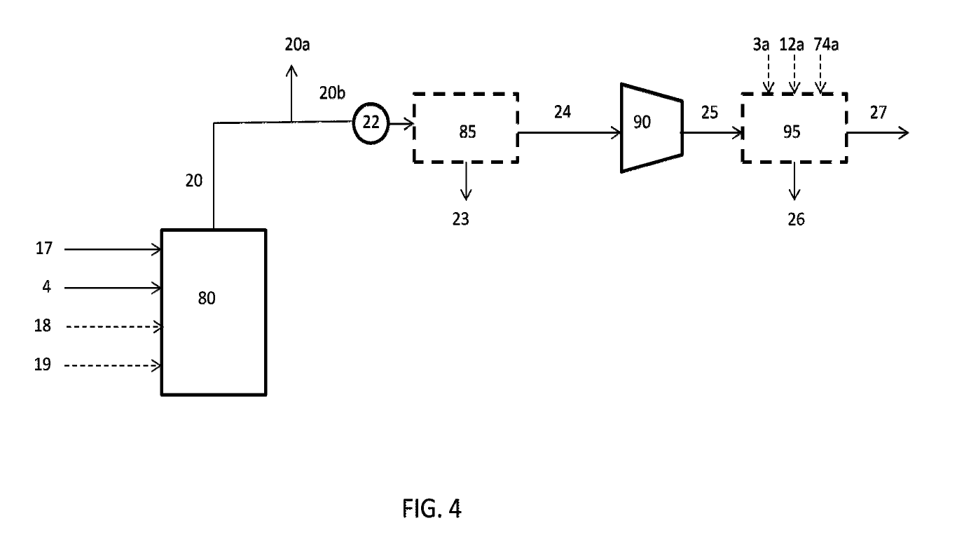

FIG. 4 illustrates one embodiment in which a refinery heater 80 utilizes the low-carbon fuel gas 4 as fuel and in which an alternative sweep gas stream is produced. Air stream 17 is also fed to the heater, as well as optional conventional refinery fuel gas or natural gas 18 and optional steam 19. Hot exhaust gas 20 exits the top of the heater 80. The exhaust gas 20 contains nitrogen, water and oxygen. A portion of exhaust gas is vented as 20a. Valve 22 controls the rate of flow of the remainder of exhaust gas 20b. The temperature of stream 20b can be reduced in optional cooler 85 to a temperature of between about 30° C. and about 50° C., thus condensing out water 23. Cooled exhaust gas 24 is then compressed by compressor 90, and the resulting nitrogen-containing gas stream 25 can be used as the sweep gas 2 across the permeate side of the first hydrogen membrane 35, or as the sweep gas 78 across the permeate side of the second hydrogen membrane 72, as previously described. Gas stream 25 may also include some oxygen and small amounts of other components.

The pressure of gas stream 25 can be maintained at between about 3 and about 6 bar depending on the fuel gas pressure required at the refinery equipment feed point, in order to avoid recompression of the low-carbon fuel gas 4 prior to its use. The temperature of the gas stream 25 may be adjusted suitably in a heat exchanger (not shown) depending on the membrane temperature requirement. The flow rate of the gas stream 25 is adjusted to obtain the required H₂ purity in the combined fuel gas stream as described above as would be apparent to one skilled in the art.

A de-oxo unit 95 may optionally be used to remove oxygen from nitrogen-containing gas stream 25, resulting in stream 27 which can be used in the same ways as nitrogen-containing gas stream 25, as previously described. In this case, the O₂ in the nitrogen-containing gas stream 25 is removed in a de-oxo unit in which oxygen and hydrogen react in the presence of a catalyst to form water. The de-oxo unit 95 is supplied with a small amount of H₂, which can be taken from a hydrogen-enriched stream, i.e., at least one of hydrogen-enriched streams 3, 12 and 74. For instance, a portion of hydrogen-enriched permeate stream 3 can be fed to de-oxo unit 95 as hydrogen stream 3a. Similarly, a portion of hydrogen-enriched stream 12 can be fed to de-oxo unit 95 as hydrogen stream 12a. Alternatively, a portion of hydrogen-enriched permeate stream 74 can be fed to de-oxo unit 95 as hydrogen stream 74a. The removal of O₂ upstream of the membrane unit can be advantageous to limit the temperature rise in the membrane from the reaction between H₂ and O₂ in the sweep stream, i.e., at least one of sweep streams 2 and 78, particularly when the membrane is operated at temperatures in excess of 150° C. The compressor 90 and the de-oxo unit 95, in addition to an optional heat exchanger (not shown), can be used to increase the temperature of the gas stream 27. This can be advantageous when gas stream 27 is used as sweep gas stream 2 and/or 78 in that the temperature of stream 27 can be adjusted to approximate that of the membrane unit, if high-temperature membranes are employed.

In one embodiment, the carbon dioxide-containing stream 11 may further be compressed to a suitable pressure, e.g., about 100 bar to about 200 bar, and injected into a subterranean formation for enhanced oil recovery or storage in suitable geological formations.

Where permitted, all publications, patents and patent applications cited in this application are herein incorporated by reference in their entirety, to the extent such disclosure is not inconsistent with the present invention.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

From the above description, those skilled in the art will perceive improvements, changes and modifications, which are intended to be covered by the appended claims.

What is claimed is:

1. A process for providing a fuel gas for refining operations, comprising:
a) passing a first gaseous mixture comprising hydrogen and methane across a first hydrogen separation membrane having a retentate side and a permeate side wherein the first gaseous mixture is passed across the retentate side to form a first hydrogen-enriched stream and a first hydrogen-depleted retentate stream;
b) passing a sweep gas across the permeate side of the first hydrogen separation membrane to enhance the hydrogen flux across the membrane;
c) reforming the first hydrogen-depleted retentate stream in a reformer to form a second gaseous mixture comprising hydrogen, carbon monoxide, carbon dioxide and water;
d) passing the second gaseous mixture through a water gas shift reactor to form a third gaseous mixture comprising hydrogen and carbon dioxide;
e) separating the third gaseous mixture into a second hydrogen-enriched stream and a carbon dioxide-containing stream; and
f) combining the first and second hydrogen-enriched streams to form a low-carbon fuel gas stream containing at least about 50 mol % hydrogen.

2. The process of claim 1, wherein the first gaseous mixture is a refinery fuel gas.

3. The process of claim 1, further comprising:
g) using the low-carbon fuel gas as fuel for refinery equipment.

4. The process of claim 3, wherein the refinery equipment is selected from heaters and boilers.

5. The process of claim 3, wherein carbon dioxide emissions from the refinery equipment are reduced by at least about 50% as compared to carbon dioxide emissions when refinery fuel gas or natural gas is used as a fuel in the refinery equipment.

6. The process of claim 1, wherein the sweep gas is a nitrogen-containing gas stream taken from an air separation unit.

7. The process of claim 1, wherein the hydrogen separation membrane is selected from the group consisting of metallic membranes, porous inorganic membranes, and nonporous polymeric membranes.

8. The process of claim 1, wherein the third gaseous mixture is separated into the second hydrogen-enriched stream and the carbon dioxide-containing stream using a membrane selected from the group consisting of metallic membranes and porous inorganic membranes.

9. The process of claim 1, further comprising:
passing the third gaseous mixture across the retentate side of a second hydrogen separation membrane having a retentate side and a permeate side to form a hydrogen-depleted retentate stream;
passing the hydrogen-depleted retentate stream through a cryogenic carbon dioxide purification unit to form a carbon dioxide-depleted stream containing hydrogen, methane, carbon dioxide and carbon monoxide; and
sending the carbon dioxide-depleted stream to at least one of the following:
i. to the permeate side of the first hydrogen separation membrane as the sweep gas;
ii. to the permeate side of the second hydrogen separation membrane as a sweep gas;
iii. to the retentate side of the first hydrogen separation membrane as a feed gas; and
iv. to the reformer as a feed gas.

10. The process of claim 1, wherein the first gaseous mixture comprises at least about 5 mol % hydrogen, the first hydrogen-enriched stream comprises at least about 10 mol % hydrogen, the second hydrogen-enriched stream comprises at least about 70 mol % hydrogen, and the low-carbon fuel gas comprises at least about 50 mol % hydrogen.

11. The process of claim 1, wherein the low-carbon fuel gas provides fuel for a furnace heater used to heat a steam methane reformer for reforming the first hydrogen-depleted retentate stream.

12. The process of claim 3, wherein the low-carbon fuel gas is mixed with at least one of natural gas and refinery fuel gas prior to using as fuel in refinery equipment.

13. The process of claim 1, wherein the low-carbon fuel gas provides fuel for refinery equipment selected from heaters and boilers such that nitrogen-containing exhaust is formed and further comprising:
cooling a portion of the exhaust to a temperature between about 30° C. and about 50° C.;
compressing the cooled exhaust to a pressure between about 3 and about 6 bar; and
using the compressed exhaust as a sweep gas across the permeate side of at least one of the first hydrogen separation membrane and the second hydrogen separation membrane.

14. The process of claim 13, further comprising passing the compressed exhaust through a de-oxo unit to remove oxygen from the compressed exhaust prior to using the compressed exhaust as a sweep gas.

15. The process of claim 1, further comprising compressing the carbon dioxide-containing stream to a pressure between about 100 bar and about 200 bar and injecting the compressed carbon dioxide-containing stream into a subterranean formation for at least one of enhanced oil recovery and storage in geological formations.
